(19) United States
(12) Patent Application Publication
(10) Pub. No.: US 2025/0061480 A1
(43) Pub. Date: Feb. 20, 2025

(54) ELECTRONIC MESSAGE REPLY CRITERIA TRACKING AND COMPENSATION INITIATION SYSTEMS AND METHODS

(71) Applicant: DYLAN W. DELANCEY, Prairie Village, KS (US)

(72) Inventor: DYLAN W. DELANCEY, Prairie Village, KS (US)

(21) Appl. No.: 18/806,485

(22) Filed: Aug. 15, 2024

Related U.S. Application Data
(60) Provisional application No. 63/633,751, filed on Apr. 13, 2024.
(60) Provisional application No. 63/541,747, filed on Sep. 29, 2023.
(60) Provisional application No. 63/537,747, filed on Sep. 11, 2023.
(60) Provisional application No. 63/532,857, filed on Aug. 15, 2023.

(51) Int. Cl. G06Q 30/0207; G06Q 50/00

(52) U.S. Cl. CPC G06Q 30/0239; G06Q 50/01

(57) ABSTRACT

Systems and methods for incentivizing responses to messages via compensation are provided. A method comprises using machine readable instructions to: (a) receive a receiving message; (b) identify in a system database a compensation message that (i) has a reply compensation deadline time that is greater than or equal to a receiving message time; and (ii) a recipient of said receiving message is the same as a send of said compensation message; (c) adjust a compensation amount based on a difference between said reply compensation deadline time and said receiving message time; and (d) trigger a compensation to a recipient of said compensation message. The system and methods include capabilities for factoring the time value of money and/or for sorting messages in different ways to help a recipient determine maximum profitability in a given amount of time. The system and methods include alerts and/or messages to recipients with information and details regarding the compensation messages and/or the sending user.

### CROSS-REFERENCE TO RELATED APPLICATIONS

This application incorporates by reference the entirety of U.S. patent application Ser. No. 17/819,919, now U.S. Patent Publication No. 2022/0394006, filed Aug. 15, 2022, and claims priority to U.S. Provisional Patent Application No. 63/532,857, filed Aug. 15, 2023, U.S. Provisional Patent Application No. 63/537,747, filed Sep. 11, 2023, U.S. Provisional Patent Application No. 63/541,747, filed Sep. 29, 2023, and U.S. Provisional Patent Application No. 63/633,751, filed Apr. 13, 2024 (the “Prior Provisionals”), the entire disclosures of which are incorporated herein by reference.

### FIELD OF THE INVENTION

The present invention relates generally to message systems and, more particularly, to methods and systems for compensating a message recipient for replying to a message. Further, various embodiments of the present invention relate to a social media or other electronic messaging applications incorporating methods and systems for compensating a message recipient for replying to a message.

### BACKGROUND OF THE INVENTION

Message systems, such as SMS messages, email, social media applications, and the like, enable users to conveniently send brief messages to other users without the need to call the user or otherwise speak to the user. Recipients of such messages, however, may be inclined to simply read the message and not reply, or simply ignore the message altogether. Known message systems do not enable a sender to incentivize and otherwise induce a recipient to read and respond to a message. As a result, there is a need for an application that provides a mechanism for a sender to induce a reply message from a recipient, such as described in U.S. Patent Publication No. 2022/0394006.

### SUMMARY OF THE INVENTION

The instant invention provides for an electronic messaging application, including, but not necessarily limited to a social media application and/or messaging functionality of a social media application. Some embodiments of the application comprise a home page including a feed of social media posts, a favorites page including content from pages followed or subscribed to, a chat function, a search function, and menu. The chat function generally includes messages from all, messages from favorites (which, in some embodiments, includes subscribers or pages subscribed to and/or followers or pages followed), and the ability to send a new message. The chat function also provides a system and method for sending a message to induce a reply from the recipient by awarding compensation based upon a reply deadline and reply time. In some embodiments, such messages are compensation messages as described in U.S. Patent Publication No. 2022/0394006.

In some embodiments, the application includes a user interface presented on a phone screen, desktop monitor, or other screens or displays. The user interface includes a list of shortcuts to different functions, which in some embodiments is at the bottom of the display. In an exemplary embodiment, this includes “Home,” “Favorites,” “Chat,” “Search,” and “Menu.” In some embodiments the list of shortcuts is fixed and remains the same on each page. Therefore, clicking a shortcut takes the user to a different page on the application—e.g. the home feed or the search function—but the list of shortcuts remains stationary on the display.

In some embodiments, selecting one of the shortcuts changes one or more of the short cut buttons while keeping one or more the same. For example, in one embodiment, selecting the “Chat” shortcut keeps the “Home” short cut stationary but changes the “Favorites” shortcut to “From Fav” (i.e. messages from favorite users), the “Chat” shortcut to “Right/Back” (i.e. the function for sending a message to induce a replay as described further herein), the “Search” to “From All” (i.e. messages from all other users) and “Menu” to “New Chat.” In some such embodiments, the list of shortcuts remains in the same place but the name and image of one or more shortcuts—as well as their destination—change accordingly. In some such embodiments, clicking the “Home” shortcut again will take the user back to the home page and change the short cut buttons back to the original. This allows for more shortcuts without crowding the interface—e.g. the additional chat shortcuts (favorites, all, new, etc.) only appear when “Chat” is selected. It also allows for the application to be structured around a single, central navigation system.

In some embodiments, the invention organizes compensation messages—i.e. messages sent to induce a reply from the recipient by awarding compensation based upon a reply deadline and reply time. In some such embodiments, organization is based upon higher value of compensation vs. time to allow a user to maximize profit. The application factors time value of money and sorts messages in different ways to help a user determine maximum profitability in a given amount of time. For example, if a user has 100 messages with different timeframes and presently has one hour of time to respond. The application will prioritize which messages should be responded to for maximum profit.

In some embodiments, the application alerts and/or messages users information and details regarding the compensation messages and the sending user. In some embodiments, alerts and notifications are provided in accordance with the amount of time remaining to respond and/or the amount of compensation. Therefore, more frequent and/or intrusive alerts are sent for larger compensation amount or messages near a deadline. In some embodiments, the alerts are dynamic. Therefore, initial alerts for a compensation message are infrequent and minor—e.g. a push notification once a day—whereas the alerts become more frequent and extreme as the deadline nears—e.g. activation of flashing lights and audio alerts every 30 minutes.

In some embodiments, alerts include the message, the timing of the message, details regarding the message and the sender, details regarding compensation, response deadlines, and details regarding the response. In some embodiments, such information being provided is also dynamic.

In some embodiments, the application has access to a user's existing hardware, such as a cellphone flashlight or cellphone/computer audio. Such hardware is used to alert the user. In some embodiments, additional hardware is provided to the user, such as a device for audibly or visually alerting the user. In some embodiments, the additional hardware is connected to the users existing device (e.g. an additional light attached to a cellphone) or, in some embodiments, the additional hardware is used as a standalone device(s).

In some embodiments, the application includes user verification to verify the identify of users sending and/or receiving compensation messages. In some embodiments, the application includes verification for all users. In some embodiments, an indicator that a user is verified is provided. In some embodiments, this includes a shield or a checkmark next to the user's account name. In some embodiments, verification is done by a third party.

The compensation messages generally include a specific custom request, a response time, and a compensation amount and structure. For example, a request may be for a certain celebrity to send back a photograph in a certain shirt by a certain time for a certain amount of money. In some embodiments, the compensation message includes a compensation amount with no deadline time. In other embodiments, the compensation message includes a deadline time that cancels automatically at a preset time.

In some embodiments, both the person sending the compensation message and receiving the compensation message approve the request. In some embodiments, this includes approving the compensation and compensation formula. In some embodiments, the compensation formula is emailed, sent via the application, or otherwise sent to the recipient of the compensation message so that it may be approved by them. In some embodiments both persons verify the service was rendered—e.g. that the celebrity did send the photograph in time. In some embodiments the users rate each other and leave revies. In some embodiments, the compensation is not paid out to the user who received the compensation message until both parties verify the response was made in accordance with the request.

In some embodiments the funds are not paid out or—if already collected—returned to the user who generated the compensation message if the deadline past, the response message is sent past the deadline, both users do not agree the request was satisfied, user status change, user verification fails, and/or other conditions are not satisfied. In some embodiments, a dispute system is included to resolve disputes between users.

In some embodiments, users are capable of following and/or subscribing to other users on the application. In some embodiments, the application provides for an empty heart next to a user's name or post. When another user click the heart once, it fills up halfway and indicates the user is now following the other user. With another click, the heart fills up entirely and indicates the user is now subscribed to the other user. Another click makes the heart empty again and clears the follow and subscription. Therefore, clicking the heart allows a user to toggle between following, following and subscribing, or unfollowing/unsubscribing from another user. In some embodiments, subscribing to another user includes paying them fee. In some embodiments this is a specified monthly fee but it will be appreciated that other subscription structures are used in various embodiments. In some embodiments, payment information is entered and saved into the application to allow for easier and instantaneous click and subscribe.

In some embodiments, a chat bubble is provided next to a user's name or post. When another user clicks the bubble, the new message screen is displayed.

Some embodiments include a bidding system wherein users are capable of bidding a compensation amount for certain requests. For example, the application enables users to bid to communicate with someone (another user) at a specified time. The first user is able to set-up a time for the communication and then other users bid on the price to communicate at that time. In another example, a user—perhaps a celebrity—sets up a video call and users bid for the right to be on the call.

Various embodiments of the inventive concept include applications and methods for use in sales, marketing, advertising, and lead generation. In such embodiments the compensation messages and/or other functionality of the inventive concept aid in increasing sales, marketing exposure, advertising exposure, and/or lead generation.

In some embodiments, the inventive concept includes applications and methods in which a compensation message of the inventive concept is utilized to solicit a response signature. In some such embodiments the signature is obtained via electronic means, such as DocuSign.

In some embodiments, the inventive concept includes applications and methods in which a compensation message of the inventive concept is utilized to solicit a recipient to participate in a survey, presentation, product/services offering, or other program or advertising model. For example, in some embodiments, a recipient receives a compensation message that provides the recipient a compensation amount for reviewing a promotional video/advertisement within a certain period of time (or scaled compensation amounts as set forth above). In other embodiments, a recipient receives a compensation message that provides the recipient a compensation amount (or scaled compensation amounts) for purchasing a product or services, such as signing up for a monthly residential alarm monitoring services, for signing up for timeshares, and/or for signing up for cellular service, etc. In some embodiments, the act of processing a payment to purchase a product/services within a certain time is the condition that is required to be performed by the recipient to receive the compensation offered in the compensation message. For example, in some embodiments a recipient agrees to receive a $100 payment (or other suitable amount) upfront to sign up for a monthly recurring service such as alarm system or phone service. In some embodiments, a compensation message is utilized to solicit an investor or board member of a potential investor, or other decision maker to review pitch materials for an investment or other opportunity.

Some embodiments of the inventive concept utilizing various features to detect and/or confirm that users of the inventive system are real persons. Some such embodiments include the use of body pattern identification, body pattern movement identification, body pattern measurement, and/or user generated computer input.

In some embodiments a video or other image/motion capture device is utilized as part of the inventive concept to confirm that a recipient of a compensation message completes the task required to obtain compensation. For example, in an embodiment in which the recipient receives compensation for watching a video advertisement within a specified period of time, the image/motion capture device confirms that the recipient's attention is focused on the video. In some such embodiments, existing technology such as the Apple face ID technology is utilized in combination with the systems of method of the inventive concept.

It will be appreciated that various embodiments of the inventive concept are utilized to increase/facilitate the speed of communications and responses received. In various embodiments the inventive concept is part of the fabric of commerce and business to facility faster communications.

It will be appreciated that in various embodiments of the inventive concept various features and functions described herein will be utilized through the use of both standalone hardware/software as well as through the use of various separate components (including, but not limited to components located at various separate physical locations and/or operated by one or more third parties) that are utilized in a coordinated manner to work together to accomplish the desired functionality of the inventive concept. For example, in some embodiments, a widget or other similar component is added to an existing messaging platform to provide the functionality required to accomplish the compensation message functionality of the inventive concept.

Some embodiments of the inventive concept include a compensation mechanism that in some embodiments operates as a standalone system from a messaging system/platform, and in other embodiments is integrated into the messaging system/platform. In some standalone embodiments messages are sent from a sender's messaging platform and a copy of the message is sent to the compensation mechanism. In some embodiments, the message is relayed through the compensation mechanism. In other embodiments, key data relating to the sent message is transmitted from the sender's messaging system/platform to the compensation mechanism, e.g. the time the message is sent, reply deadline (actual time reply is requested or amount of time the recipient has to reply), amount and any scaling data, and any other parameters required to comply with the request. In some embodiments, the transmitting of data, relaying or copying of messages of the inventive concept is accomplished through the use of an API, extension, or other functionality added to the messaging system/platform. In some embodiments of a standalone compensation mechanism, a recipient's reply to a message of the inventive concept is either relayed through or copied to the compensation mechanism. In other embodiments, the sender's messaging system includes functionality (e.g. API, extension, etc.) that transmits key data relating to the recipients reply to the compensation mechanism, such as time reply is sent by recipient (or time reply is received by sender), and/or any other data necessary or desired to confirm compliance with the sender's request.

In some embodiments of the inventive concept, the compensation mechanism stores key data regarding a sender's request in one or more databases accessible by the compensation mechanism (e.g. time sent, deadline, amount of offer and any scaling data, other parameter to comply with the request, etc. In some embodiments, the compensation mechanism utilizes data obtain from the sent message and data from a reply message to match/marry a sent message to a reply message. In some embodiments, a message ID is assigned to each sent message. In some such embodiments the message ID is assigned at the time the message is created/sent. In other embodiments the message ID is assigned by the compensation mechanism after data has been transmitted from the messaging system to the compensation system. In some embodiments in which the message ID is assigned at the time the message is created/sent, the same message ID is also included in any reply made by the recipient to allow the compensation mechanism to marry the sent message to the reply. In embodiments in which a message ID is not assigned at the time the message is created/sent, the compensation mechanism uses other data relating to the sent message and reply message(s) to marry correctly sent and reply messages. In various embodiments, such data includes, but is not limited to the following data contain in sent messages and/or reply messages: sender email/messaging address/ID, message sent time, compensation amount, recipient email/messaging address/ID.

In some embodiments of the inventive concept, once the sent and reply messages are married, the compensation mechanism determines of the request contained in the sent message has been completed, and the amount of compensation required. In some embodiments, the compensation mechanism includes a step of confirming/verifying with the sender and/or the recipient that all requirements for compensation have been completed. In some embodiments of the inventive concept, upon determination and/or verification of an amount of compensation required by the compensation mechanism, the compensation mechanism initiates completion of compensation to the recipient. In some such embodiments, the completion of compensation includes transferring of funds from a prepaid account of the sender to the recipient. In other embodiments, the compensation mechanism initiates a request for funds, or transfer of funds from the recipient. In some such embodiments, the request for funds is the processing of a recipients credit card, debit card, electronic funds transfer, or other electronic transfer from an account of sender. In some embodiments, the sender's payment account information is provided to the compensation mechanism (or to another payment mechanism accessible by the compensation mechanism) prior to or at the same time as the creation/sending of the original message. In some embodiments, the compensation mechanism obtains funds from the sender and then transfers funds to the recipient. In some such embodiments, the compensation mechanism charges a transaction fee that is included in the funds received from the sender. In other embodiments, the compensation mechanism merely facilitates (or helps to facilitate) a transfer of funds either directly from sender to recipient or through a 3^{rd} party service. In some such embodiments, the compensation mechanism charges and/or receives a service fee at the same time a funds transfer transaction is facilitated. In some embodiments the service fee for the compensation mechanism is an additional charge made to the sender in addition the whatever compensation amount is to be paid to the recipient. In other words, the sender is responsible for the service fee. In other embodiments, the compensation mechanism service fee is reduced from the compensation amount provided to the recipient. In other words, the recipient is responsible for the service fee. In still other embodiments, the service fee is split by the sender and recipient. In still other embodiments, the service fee is a subscription service fee charge for a set number of transactions and/or a set period of time (e.g. monthly). In still other embodiments, the service fee is provided from various other 3^{rd} party sources.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

Preferred embodiments of the present invention, illustrative of the best mode in which the applicant has contemplated applying the principles, is set forth herein and is shown in the appendices attached hereto.

Appendix A is an exemplary embodiment of an application of the present invention.

Appendix B provides details regarding some embodiments of the systems and methods of the present invention.

Appendix C provides some embodiments of the systems and methods of the present invention for calculating compensation for a specified timeframe. Systems and methods involving scaling and no scaling are shown. An exemplary input for “AMOUNT OWED WITH SCALING” is =IF(“SECOND TIME”>“DEADLINE TIME”, 0, MAX(0,(“ORIGINAL COMPENSATION AMOUNT”+(((“COMPENSATION AT DEADLINE”−“ORIIGNAL COMPENSATION AMOUNT”)/(“DEADLINE TIME”−“TIME”)))*(“SECOND TIME”−“FIRST TIME”)))), which also is expressible as =IF(D3>H3, 0, MAX(0,(G3+(((I3−G3)/(H3−D2)))*(D3−D2)))) in the attached spreadsheet.

1. A computer-implemented method, comprising: using machine readable instructions to:
(a) receive an electronic receiving message;
(b) identify in a system database a compensation message that:
(i) has a reply compensation deadline time that is greater than or equal to an electronic receiving message time; and
(ii) a recipient of said electronic receiving message is the same as a sender of said compensation message;
(c) adjust a compensation amount based on a difference between said reply compensation deadline time and said electronic receiving message time;
(d) generate payment transaction data, wherein said payment transaction data includes recipient identification information and compensation amount;
(e) transmit said payment transaction data to a payment processor; and
(f) trigger a monetary compensation to a recipient of said compensation message; wherein said computer-implemented method includes capabilities for factoring the time value of money and/or for sorting messages in different ways to help a recipient determine maximum profitability in a given amount of time.

2. The method of claim 1, further including alerts and/or messages said recipient with information and details regarding said compensation message and/or a sender.

3. The method of claim 1, wherein said recipient of said electronic receiving message and said recipient of said compensation message are different.

4. The method of claim 1, further comprising creating a message record, said message record comprising a field for each of a compensation history associated with said compensation message, said compensation history including a message identifier, a message content, a deadline, a deadline amount value, a file name, and a compensation adjustment function.

5. The method of claim 1, further comprising creating a message record comprising a deadline amount value.

6. The method of claim 1, further comprising creating a message record comprising a deadline.

7. The method of claim 1, further comprising creating a message record comprising a payment indicator indicating a payment between said recipient of said electronic receiving message and a recipient of said compensation message.

8. The method of claim 1, further comprising creating a message record comprising a payment indicator indicating a payment between said recipient of said electronic receiving message and a recipient of said compensation message based on an adjustable payment function.

9. The method of claim 1, wherein said electronic receiving message time is associated with a time said electronic receiving message is received at a computer.

10. The method of claim 1, wherein said electronic receiving message time is associated with a time said electronic receiving message is received at a computer and saved in a database.

11. The method of claim 1, wherein said electronic receiving message time is a time said electronic receiving message is sent by a recipient of said compensation message.

12. A system, comprising:
a computer program that is encoded on a machine non-transitory readable storage medium in a server, and is accessible by one or more computing devices to use the functionality of, the computer program including connection with a messaging service;
a database for storing input data pertaining to a plurality of compensation messages, said input data including a reply compensation value, a reply deadline, a recipient, and message content; and
wherein a plurality of different system users are connected with said messaging service;
wherein said computing devices are configured to allow one or more of said system users to send a compensation message;
wherein said computing devices are configured to allow one or more of said system users to send an electronic receiving message to another one of said system users, wherein said electronic receiving message is associated with a particular compensation message;
wherein upon receipt of an electronic receiving message, said computer program adjusts the reply compensation value associated with the compensation message based on a difference between the time said electronic receiving message is received and said reply deadline;
wherein said computer program generates payment transaction data and transmits said data transaction data to a payment processor, wherein said payment transaction data includes payment account data of a user to be compensated and said compensation value; and
wherein said computer program includes capabilities for factoring the time value of money and/or for sorting messages in different ways to help said recipient determine maximum profitability in a given amount of time.

13. The system of claim 12, further including alerts and/or messages said recipient with information and details regarding said compensation message and/or a sender.

14. The system of claim 12, wherein said computer program further sends the adjusted compensation value to said system user who sent said electronic receiving message.

15. The system of claim 12, wherein said computer program further verifies that the recipient of said electronic receiving message is the same as the sender of said associated compensation message.

16. The system of claim 12, wherein said database further stores a message record for each system user.

17. The system of claim 16, wherein said message record includes a payment indicator.

18. The system of claim 12, wherein the time said electronic receiving message is received is the time said electronic receiving message is saved in said database.

19. An electronic message reply criteria tracking and compensation initiation system comprising a computer program encoded on a machine non-transitory readable storage medium that accesses:
a messaging service; and
a database for storing input data pertaining to a plurality of compensation messages, said input data including a reply compensation value, a reply deadline, a recipient, and message content;
wherein a plurality of different system users are connected with said messaging service;
wherein said computing devices are configured to allow one or more of said system users to send a compensation message;
wherein said computing devices are configured to allow one or more of said system users to send an electronic receiving message to another one of said system users, wherein said electronic receiving message is associated with a particular compensation message;
wherein upon receipt of an electronic receiving message, the reply compensation value associated with the compensation message is adjusted based on a difference between the time said electronic receiving message is received and said reply deadline, thereby generating a final compensation value;
wherein upon generating a final compensation value, said computer program generates payment transaction data and transmits said data transaction data to a payment processor, wherein said payment transaction data includes payment account data of a user to be compensated and said final compensation value; and
wherein said computer program includes capabilities for factoring the time value of money and/or for sorting messages in different ways to help said recipient determine maximum profitability in a given amount of time.

20. The system of claim 19, further including alerts and/or messages said recipient with information and details regarding said compensation message and/or a sender.
